(19) United States
(12) Patent Application Publication
(10) Pub. No.: US 2024/0425406 A1
(43) Pub. Date: Dec. 26, 2024

(54) PROCESS FOR FABRICATING CHLORO ALKALI PHOSPHATE DOPED/ CODOPED BY RARE EARTH IONS FOR OPTICAL LASER AMPLIFIERS

(71) Applicants: Haitham Elhosiny Ali, Abha (SA); King Khalid University, Abha (SA)

(72) Inventors: El Sayed Yousef, Abha (SA); Hamed Algarni, Abha (SA); Haitham Elhosiny Ali, Abha (SA); Yasmin Khairy, Abha (SA); Awad A. Ibraheem, Abha (SA); Mohd Shkir, Abha (SA); Mohammed S. Alqahtani, Abha (SA); A.M. Alshehri, Abha (SA); Bozena Burtan-Gwizdala, Cracow (PL); Manuela Reben, Cracow (PL); Christian Russel, Jena (DE)

(21) Appl. No.: 18/825,753

(22) Filed: Sep. 5, 2024

(51) Int. Cl. C03C 4/12; B24B 7/24; C03B 3/02; C03B 5/173; C03B 5/187; C03B 5/24; C03B 19/02; C03B 25/02; C03B 27/02; C03B 40/02; C03C 3/247; C03C 17/245; C03C 21/00; C03C 23/00; C09K 11/77

(52) U.S. Cl. CPC C03C 4/12; B24B 7/241; C03B 3/02; C03B 5/173; C03B 5/187; C03B 5/24; C03B 19/02; C03B 25/02; C03B 27/022; C03B 40/02; C03C 3/247; C03C 17/245; C03C 21/002; C03C 23/004; C09K 11/7796; C03B 2201/70; C03C 2204/00; C03C 2217/734; C03C 2218/152

(57) ABSTRACT

The present invention generally relates to a process for fabricating Chloro Alkali Phosphate Doped/Codoped by rare earth ions for optical laser amplifiers. The process includes mixing 38-42 wt. % of Phosphorus pentoxide (P₂O₅), 28-32 wt. % of Zinc oxide (ZnO), 9-11 wt. % of Barium fluoride (BaF₂), 17-19 wt. % of Lithium chloride (LiCl), and 1-3 wt. % of Lead(II) fluoride (PbF₂); filling a silica, platinum, and alumina crucible to the mixture; heating the mixture upon increasing a furnace temperature to 1000-1050° C. at a rate of 10° C. per minute and maintaining it for two hours to melt the glass; and pouring the glass melt into a preheated stainless steel mold at 350° C. and transferring the mold to a holding furnace heated to 350-370° C. and annealing for two hours thereby cooling to room temperature to obtain Chloro Alkali Phosphate matrix glass that is undoped, doped, or codoped with high thermal stability.

### FIELD OF THE INVENTION

The present disclosure relates to a tellurite glass with low thermal expansion and high thermal stability and a preparation process thereof, belonging to the technical field of glass materials and preparation. More particularly, the present invention relates to a process is used for fabricating Chloro Alkali Phosphate Doped/Codoped by rare earth ions for optical laser amplifiers.

### BACKGROUND OF THE INVENTION

Several researchers created low dispersion, reasonably high refractive index phosphate glasses over a century and a half. Comparing alkaline earth phosphate glasses to silicate glasses, the former demonstrated interesting features that resulted from their amazing transparency to UV, Vis, NIR, IR light.

The usage of amorphous alkali phosphates in various industrial applications, such as clay processing and pigment manufacture, raised interest in them in the 1950s. These applications included sequestering agents for mineral water treatments.

The foundation for understanding the nature of phosphate glasses has been established by a researcher. A new phase in phosphate glass research started in with the development of solid-state lasers in the 1960s. Certain compositions are the preferred materials, especially for high power laser applications, since they exhibit large rare-earth stimulated emission cross-sections and low thermo-optical coefficients (compared with silicate glasses).

In addition, there are several related to technology uses for phosphate glasses. Composes of zinc phosphate may be co-formed with high-temperature polymers to create unique organic/inorganic composites, and they have processing temperatures below 400° C. and chemical durability.

The phosphate glasses have becoming more popular as nuclear waste hosts due to their low processing temperature and chemical durability.

The phosphorus oxynitride and amorphous lithium phosphate glasses are valuable as solid-state electrolytes due to their high ion conductivity. In addition, rare earth chemical solubility in phosphate glasses is much greater than in silicate oxide-based glasses. Specifically, because of their many beneficial qualities, including their high gain coefficients and very high solubility for rare earth ions, phosphate glasses were shown to be an ideal device for the amplification of RE ion luminescence. This was especially evident when compared to tellurite glasses.

It is generally believed that rare earth elements, which have been incorporated in the empty space between [PO₄] tetrahedral, function as network modifiers in the glasses. The cationic field strength (CFS) of the lanthanide elements varies constantly with their atomic number due to an ongoing decrease of their ionic radii with increasing atomic number.

Active rare earth elements including ytterbium and neodymium are doped into host glass systems to generate laser glasses. Because of the stimulated emission of the excited rare earth element ions inside the glass, these rare earth doped laser glasses are able to produce lasing. The following materials have also been used as host glass matrix systems for lasing ions: tellurite, silicates, borates, boro-silicates, and aluminates.

In view of the foregoing discussion, it is portrayed that there is a need to have a process for fabricating Chloro Alkali Phosphate Doped/Codoped by rare earth ions for optical laser amplifiers. The phosphate glass composition activated with different rare earth, such as Eu³⁺, and/or Er³⁺, Yb³⁺ and Nd³⁺.

### SUMMARY OF THE INVENTION

The present disclosure seeks to provide an easy-to-use preparation process, a low melting temperature, economical manufacturing, good thermal stability, and superior anticrystallization optical performance. undoped and doped Chloro Alkali Phosphate glass doped with (Eu, Er Yb, Nd) and co-doped (Eu/Er, Eu/Yb, Eu/Nd) and its preparation method. The resulting glass exhibits excellent lasing material, low OH, chemical durability, and anticrystallization. The invention also refers to a laser glass that has been doped with Er, Yb, Nd, Eu, or any combination of these dopants, with a peak emission wavelength and appropriate lasing characteristics. Additionally, the glass created by this innovation has a rather broad full width at half maximum (FWHM) emission of fluorescence. This glass's characteristics make it appropriate for creating planar waveguides and superior optical fibers.

In an embodiment, a composition for fabricating Chloro Alkali Phosphate Doped/Codoped by rare earth ions for optical laser amplifiers is disclosed. The composition includes 38-42 wt. % of Phosphorus pentoxide (P₂O₅); 28-32 wt. % of Zinc oxide (ZnO); 9-11 wt. % of Barium fluoride (BaF₂); 17-19 wt. % of Lithium chloride (LiCl); and 1-3 wt. % of Lead(II) fluoride (PbF₂).

In another embodiment, a process for fabricating Chloro Alkali Phosphate Doped/Codoped by rare earth ions for optical laser amplifiers is disclosed. The process includes mixing 38-42 wt. % of Phosphorus pentoxide (P₂O₅), 28-32 wt. % of Zinc oxide (ZnO), 9-11 wt. % of Barium fluoride (BaF₂), 17-19 wt. % of Lithium chloride (LiCl), and 1-3 wt. % of Lead(II) fluoride (PbF₂). The process further includes filling a silica, platinum, and alumina crucible to the mixture. The process further includes heating the mixture upon increasing a furnace temperature to 1000-1050° C. at a rate of 10° C. per minute and maintaining it for two hours to melt the glass. The process further includes pouring the glass melt into a preheated stainless steel mold at 350° C. and transferring the mold to a holding furnace heated to 350-370° C. and annealing for two hours thereby cooling to room temperature to obtain Chloro Alkali Phosphate matrix glass that is undoped, doped, or codoped with high thermal stability.

An object of the present disclosure is to produce glass compositions with a low glass transition temperature, facilitating ease of processing and use in various applications.

Another object of the present disclosure is to achieve a specific refractive index tailored for optical applications, ensuring optimal light propagation characteristics.

Another object of the present disclosure is to enhance the chemical durability of the glass compositions, enabling long-term stability and resistance to degradation in harsh environments. The invention targets glass compositions with high thermal stability, capable of withstanding elevated temperatures without significant alteration in their properties.

Another object of the present disclosure is to optimize the lasing parameters of the glass compositions, including fluorescence lifetime, emission wavelength, gain, and bandwidth, to enable efficient laser amplification.

Yet another object of the present invention is to deliver an expeditious and cost-effective glass composition suitable for fabricating optical laser glasses spanning the UV-Vis-NIR and IR spectra, adaptable to different pumping excitation wavelengths and rare earth ion combinations.

To further clarify the advantages and features of the present disclosure, a more particular description of the invention will be rendered by reference to specific embodiments thereof, which are illustrated in the appended drawings. It is appreciated that these drawings depict only typical embodiments of the invention and are therefore not to be considered limiting of its scope. The invention will be described and explained with additional specificity and detail in the accompanying drawings.

### BRIEF DESCRIPTION OF FIGURES

These and other features, aspects, and advantages of the present disclosure will become better understood when the following detailed description is read concerning the accompanying drawings in which like characters represent like parts throughout the drawings, wherein:

FIG. 1 illustrates a flow chart of a process for fabricating Chloro Alkali Phosphate Doped/Codoped by rare earth ions for optical laser amplifiers in accordance with an embodiment of the present disclosure;

FIG. 2 illustrates DTA profile of all prepared glasses;

FIG. 3 illustrates the Absorption spectrum of PZnBaLiPb;

FIG. 4 illustrates the Absorption spectrum of PZnBaLiPb_Eu (35000 ppm);

FIG. 5 illustrates the Absorption spectrum of PZnBaLiPb_Er (35000 ppm);

FIG. 6 illustrates the Absorption spectrum of PZnBaLiPb_Yb (35000 ppm);

FIG. 7 illustrates the Absorption spectrum of PZnBaLiPb_Nd (35000 ppm);

FIG. 8 illustrates the Absorption spectrum of PZnBaLiPb_Er (35000 ppm)_Eu (35000 ppm);

FIG. 9 illustrates the Absorption spectrum of PZnBaLiPb_Yb (35000 ppm)_Eu (35000 ppm);

FIG. 10 illustrates the Absorption spectrum of PZnBaLiPb_Nd (35000 ppm)_Eu (35000 ppm);

FIG. 11 illustrates the (αhν)^{1/2} as a function of (hν) of all prepared glasses;

FIG. 12 illustrates the fluorescence emission spectra of PZNBaLiPb_Eu and PZnBaLiPb_Eu—Er glasses under an excitation wavelength of 395 nm;

FIG. 13 illustrates the fluorescence emission spectra of PZNBaLiPb_Er and PZnBaLiPb_Eu—Er glasses under an excitation wavelength of 385 nm;

FIG. 14 illustrates the fluorescence emission spectra of PZNBaLiPb_Eu and PZnBaLiPb_Eu—Yb glasses under an excitation wavelength of 395 nm;

FIG. 15 illustrates the fluorescence emission spectra of PZNBaLiPb_Eu and PZnBaLiPb_Eu—Nd glasses under an excitation wavelength of 395 nm;

FIG. 16 illustrates the fluorescence emission spectra of PZNBaLiPb_Nd and PZnBaLiPb_Eu—Nd glasses under an excitation wavelength of 585 nm;

FIG. 17 illustrates the fluorescence emission spectra of PZNBaLiPb_Eu, PZnBaLiPb_Eu−x (x=Er, Yb, Nd) glasses under an excitation wavelength of 395 nm;

FIG. 18 illustrates the excitation spectra of PZNBaLiPb_Eu and PZnBaLiPb_Eu—Er glasses under different emission wavelength of 545 nm and 1532 nm;

FIG. 19 illustrates the excitation spectra of PZNBaLiPb_Eu and PZnBaLiPb_Eu—Er glasses under an emission wavelength of 612 nm;

FIG. 20 illustrates the excitation spectra of PZNBaLiPb_Eu and PZnBaLiPb_Eu—Yb glasses under an emission wavelength of 612 nm;

FIG. 21 illustrates the excitation spectra of PZNBaLiPb_Eu and PZnBaLiPb_Eu—Nd glasses under an emission wavelength of 612 nm;

FIG. 22 illustrates the excitation spectra of PZNBaLiPb_Eu and PZnBaLiPb_Eu−x (x=Er, Nd, Yb) glasses under an emission wavelength of 612 nm;

FIG. 23 illustrates the Fluorescence decay curve of PZnBaLiPbEr and PZnBaLiPbEr_Eu glasses: ⁴I_{13/2} state of Er³⁺ ions;

FIG. 24 illustrates the Fluorescence decay curve of PZnBaLiPbEr and PZnBaLiPbEr_Eu glasses: ⁴S_{3/2} state of Er³⁺ ions;

FIG. 25 illustrates the Fluorescence decay curve of PZnBaLiPbNd and PZnBaLiPbEu_Nd glasses: ⁴F_{3/2} state of Nd³⁺ ions;

FIG. 26 illustrates the Fluorescence decay curve of PZnBaLiPbYb and PZnBaLiPbEu_Yb glasses: ²F_{5/2} state of Yb³⁺ ions;

FIG. 27 illustrates the Fluorescence decay curve of PZnBaLiPbEu and PZnBaLiPbEu_X (X=Er, Yb, Nd) glasses: ⁵D₀ state of Eu³⁺ ions;

FIG. 28 illustrates the Absorption and emission cross section for PZnBaLiPb—Er glass of the transition ⁴I_{13/2}→⁴I_{15/2};

FIG. 29 illustrates the Gain coefficient for of the transition ⁴I_{13/2}→⁴I_{15/2} of PZnBaLiPb—Er glass;

FIG. 30 illustrates the Absorption and emission cross section for PZnBaLiPb-Er_Eu glass of the transition ⁴I_{13/2}→⁴I_{15/2};

FIG. 31 illustrates the Gain coefficient for of the transition ⁴I_{13/2}→⁴I_{15/2} of PZnBaLiPb-Er_Eu glass;

FIG. 32 illustrates a Table depicting the composition of the prepared glasses;

FIG. 33 a illustrates table depicting density, refractive index, glass transition temperature T_{g}, onset crystallization temperature Tₓ, crystallization temperature Tₘ, thermal stability ΔT, Sellmeier Eₛ and dispersion energy E_{d}, and optical energy gap in (eV) of prepared glasses;

FIG. 34 illustrates a Table depicting the measured fluorescence lifetime of all prepared glasses; and

FIG. 35 illustrates a Table depicting the peak emission wavelength (λₚₑₐₖ, nm), effective bandwidths (Δλ_{eff}, nm), FWHM, The fluorescence lifetime (τₘₑₛ, μs), Peak emission cross-section (x10⁻²¹ cm²), Gain, optical gain (σₑ×τₘₑₛ)×10⁻²¹ cm² ms, and gain bandwidth (σₑ×Δλ_{eff})×10⁻²¹ cm².

Further, skilled artisans will appreciate those elements in the drawings are illustrated for simplicity and may not have necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

### DETAILED DESCRIPTION

To promote an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present disclosure will be described below in detail concerning the accompanying drawings.

In an embodiment, a composition for fabricating Chloro Alkali Phosphate Doped/Codoped by rare earth ions for optical laser amplifiers is disclosed. The composition includes 38-42 wt. % of Phosphorus pentoxide (P₂O₅); 28-32 wt. % of Zinc oxide (ZnO); 9-11 wt. % of Barium fluoride (BaF₂); 17-19 wt. % of Lithium chloride (LiCl); and 1-3 wt. % of Lead(II) fluoride (PbF₂).

In one embodiment, the weight amount of the P₂O₅, ZnO, BaF₂, LiCl, PbF₂, is preferably, 40%, 30%, 10%, 18%, and 2%, respectively.

The composition is doped with 35000 ppm R₂O₃ where R is selected from Eu, Er, Yb, Nd whereas codoped with 35000 ppm R₂O₃ where R is selected from Eu/Er, Eu/Yb, Eu, Nd.

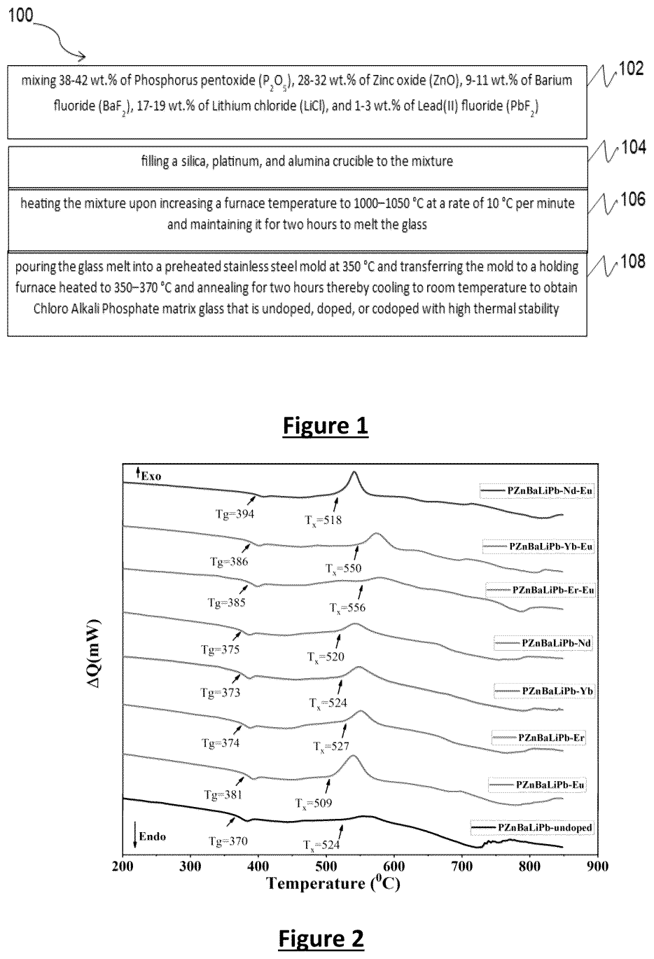

Referring to FIG. 1, a flow chart of a process for fabricating Chloro Alkali Phosphate Doped/Codoped by rare earth ions for optical laser amplifiers is illustrated in accordance with an embodiment of the present disclosure. At step 102, process 100 includes mixing 38-42 wt. % of Phosphorus pentoxide (P₂O₅), 28-32 wt. % of Zinc oxide (ZnO), 9-11 wt. % of Barium fluoride (BaF₂), 17-19 wt. % of Lithium chloride (LiCl), and 1-3 wt. % of Lead(II) fluoride (PbF₂).

At step 104, process 100 includes filling a silica, platinum, and alumina crucible to the mixture.

At step 106, process 100 includes heating the mixture upon increasing a furnace temperature to 1000-1050° C. at a rate of 10° C. per minute and maintaining it for two hours to melt the glass.

At step 108, process 100 includes pouring the glass melt into a preheated stainless steel mold at 350° C. and transferring the mold to a holding furnace heated to 350-370° C. and annealing for two hours thereby cooling to room temperature to obtain Chloro Alkali Phosphate matrix glass that is undoped, doped, or codoped with high thermal stability.

In one embodiment, the mold is preferably of a stainless steel, wherein a batch material in the crucible is covered to reduce OH— groups in the glass melt.

In another embodiment, the produced Chloro Alkali Phosphate glass has a low glass transition temperature ranging from 370 to 394° C.

Yet, in another embodiment, the mixture of 40% P₂O₅-30% ZnO-10% BaF₂-18% LiCl-2% PbF₂ doped with 35000 ppm R₂O₃ where R is selected from Eu, Er, Yb, Nd whereas codoped with 35000 ppm R₂O₃ where R is selected from Eu/Er, Eu/Yb, Eu, Nd.

In one embodiment, the glass composition PZnBaLiPbEu—Er exhibits the highest thermal stability of 124-171° C., wherein the optical energy gap of the produced glass doped with Yb ion is 4.472 eV, wherein the dispersion energy (Ed) of the produced glass falls within the range of 13.32 to 16.08 eV, and the Sellmeier energy (Es) ranges from 6.54 to 9.95 eV, wherein the produced glass compositions are suitable hosts for lasing optical amplifiers in the UV to NIR band based on their lasing parameters, thermal stability, chemical durability, and low-cost fabrication method.

In one embodiment, the mixture is subjected to a controlled atmosphere during the heating stage, specifically in an inert argon or nitrogen gas environment, to minimize oxidation of the constituent materials and prevent contamination of the glass melt, ensuring a uniform composition with minimal defect states and enhanced optical clarity, and wherein the rate of temperature increase in the furnace is precisely controlled using a programmable logic controller (PLC) with a temperature fluctuation tolerance of ±1° C. to ensure uniform heating throughout the mixture, thereby preventing localized overheating or thermal stresses that could lead to phase separation or microcracks within the glass matrix.

In one embodiment, the process further comprises pre-treating the Phosphorus pentoxide (P2O5) to remove any adsorbed moisture content by preheating at 200-250° C. in a vacuum desiccator for a period of one hour prior to mixing, thereby reducing the potential for hydrolysis reactions during the high-temperature melting process; and a secondary annealing process after the initial two-hour annealing period, wherein the mold is gradually cooled at a controlled rate of 2° C. per minute to a temperature of 250° C. before being allowed to cool to room temperature in a desiccated environment, to reduce internal stresses and improve the mechanical durability of the glass.

In one embodiment, the produced glass is subjected to a high-precision polishing procedure post-annealing, utilizing a series of progressively finer diamond abrasives down to 0.1 μm grit size, to achieve a surface roughness (Ra) of less than 5 nm, enhancing the glass's suitability for high-precision optical applications requiring minimal surface scattering, and wherein the mixture doped with 35000 ppm of R2O3, where R is selected from Eu, Er, Yb, Nd, and co-doped with Eu/Er, Eu/Yb, or Eu/Nd, is stirred continuously using a mechanical stirrer with a platinum-coated shaft at a speed of 50-100 RPM during the heating phase to ensure homogeneous distribution of dopants and prevent phase segregation within the glass matrix.

In one embodiment, the mixture of Phosphorus pentoxide (P2O5), Zinc oxide (ZnO), Barium fluoride (BaF2), Lithium chloride (LiCl), and Lead(II) fluoride (PbF2) is subjected to an ultrasonic agitation treatment at a frequency of 20-25 kHz for 15-20 minutes prior to heating to promote thorough mixing and de-agglomeration of the powder constituents, ensuring a homogeneous distribution of components and reducing the likelihood of phase separation during the melting process, and wherein the heating of the mixture is performed in a two-zone furnace, where the initial preheating zone gradually raises the temperature to 600° C. at a rate of 5° C. per minute to remove any volatile impurities, followed by a rapid transition to the high-temperature melting zone set at 1000-1050° C., thereby optimizing the thermal profile to prevent thermal shock and enhance the glass forming ability of the composition.

In one embodiment, the produced glass melt is subjected to a controlled magnetic stirring using a magnetically coupled stirring system with a rotation speed of 150-200 RPM during the pouring process into the stainless steel mold, to maintain uniform temperature distribution and prevent the formation of thermal gradients within the molten glass, ensuring a consistent microstructure throughout the glass body, and wherein the thermal stability of the PZnBaLiPbEu—Er glass composition is further enhanced by doping with 0.1-0.5 wt. % of rare-earth oxides such as Cerium oxide (CeO2) or Samarium oxide (Sm2O3), which act as nucleating agents to control crystallization during the cooling phase, thereby refining the glass microstructure and improving resistance to devitrification.

In one embodiment, the glass melt, after pouring into the preheated stainless steel mold, undergoes a rapid quenching process in a controlled atmosphere chamber filled with an inert gas mixture of argon and helium at a pressure of 0.8-1 atm, to achieve a high cooling rate that inhibits crystallization and maintains the amorphous nature of the Chloro Alkali Phosphate matrix glass.

In one embodiment, the process further comprises a step of subjecting the annealed glass to an electron beam irradiation process at an energy level of 2-3 MeV for 5-10 minutes to induce defect healing and improve the glass's optical transparency and photoluminescence properties by minimizing point defects and color centers that could arise during the high-temperature processing, and wherein the mixture doped with 35000 ppm R2O3, where R is selected from Eu, Er, Yb, Nd, and co-doped with Eu/Er, Eu/Yb, or Eu/Nd, is subjected to a high-frequency microwave-assisted synthesis process during the mixing phase, applying microwave radiation at 2.45 GHz to enhance the diffusion rates of the dopants into the glass network, leading to improved homogeneity and increased optical activation efficiency.

In one embodiment, the mold used for pouring the glass melt is pre-coated with a release agent comprising a thin layer of boron nitride (BN) to prevent adhesion between the glass and the mold surface, thereby facilitating easy demolding and reducing the risk of surface imperfections or defects on the final glass product, wherein the prepared Chloro Alkali Phosphate matrix glass is further treated with a chemical strengthening bath containing a molten mixture of potassium nitrate and sodium nitrate salts at a temperature of 450-500° C., followed by a rapid cooling phase in a chilled oil bath, to induce surface compression layers that enhance the glass's mechanical toughness and resistance to surface scratches and fractures.

In one embodiment, the mixture is subjected to an ion-beam-assisted deposition (IBAD) treatment during the mixing phase, where a directed beam of ions such as Argon or Oxygen ions is applied to the mixture, enhancing the bonding energy between Phosphorus pentoxide (P2O5) and Zinc oxide (ZnO) molecules, thereby increasing the structural integrity and chemical durability of the resulting Chloro Alkali Phosphate matrix glass, and wherein the heating step includes a stepwise thermal cycling protocol in which the temperature is repeatedly increased and decreased in controlled increments of 50° C. up to the target temperature of 1000-1050° C., creating a controlled thermal shock environment that refines the microstructure of the glass matrix by promoting uniform nucleation and preventing large crystalline growth.

In one embodiment, the mixture is doped with dual rare-earth elements in a controlled ratio of 1:1, and subjected to a high-temperature plasma annealing step post-melting, where the glass melt is exposed to a high-energy plasma environment at 1200° C. for 10 minutes, which activates rare-earth ions into higher oxidation states, significantly enhancing the photoluminescence and lasing properties of the glass for ultraviolet to near-infrared (UV-NIR) applications, and wherein the annealing step is performed under a fluctuating magnetic field of 1-2 Tesla, generated by an external electromagnetic coil, to induce magnetic domain alignment within the doped ions in the glass, thereby creating anisotropic optical properties that improve light amplification and signal gain for specific wavelengths in optical amplifier applications.

In one embodiment, the Lead(II) fluoride (PbF2) content is precisely calibrated and introduced in a stepwise manner during the heating phase, using a computer-controlled feeder mechanism to gradually increase the PbF2 concentration in the melt, thereby controlling the refractive index gradient and enhancing the optical dispersion properties of the glass for specific refractive index matching applications, and wherein the process further comprising an ultrasonic cavitation treatment of the glass melt immediately after pouring into the stainless steel mold, where the mold is subjected to ultrasonic waves at 40 kHz frequency for 5 minutes to reduce the viscosity of the glass melt and promote rapid degassing, thereby minimizing the formation of microbubbles and ensuring a defect-free, optically transparent glass matrix.

In one embodiment, the glass melt is mixed with nano-sized silica particles (10-50 nm) during the final 10 minutes of the heating phase, utilizing a high-shear mixing apparatus that operates at 10,000 RPM, to enhance the mechanical strength and thermal shock resistance of the glass without compromising its optical properties, thereby making it suitable for high-power laser applications, and wherein the Chloro Alkali Phosphate glass matrix is further coated with a thin film of antireflective material using atomic layer deposition (ALD), where layers of hafnium oxide (HfO2) and silicon dioxide (SiO2) are alternately deposited at sub-nanometer thicknesses to achieve a broadband antireflective surface with reduced Fresnel reflections, enhancing the efficiency of optical transmission in photonic devices.

In one embodiment, the cooling step in the holding furnace is performed in a gradient-controlled manner, where the temperature of the furnace is reduced at varying rates across different sections of the glass mold, creating a gradient thermal environment that induces compressive stress layers on the glass surface, significantly improving the glass's resistance to crack propagation and mechanical failure under thermal cycling conditions, and wherein the composition is subjected to a dual laser irradiation process, involving simultaneous irradiation with both a continuous wave laser at 532 nm and a pulsed laser at 1064 nm, during the final phase of annealing, to selectively modify the electronic band structure and enhance the non-linear optical properties of the glass, such as second harmonic generation and two-photon absorption.

The present invention aims to provide an easy-to-use preparation process, a low melting temperature, economical manufacturing, good thermal stability, and superior anticrystallization optical performance. undoped and doped Chloro Alkali Phosphate glass doped with (Eu, Er Yb, Nd) and co-doped (Eu/Er, Eu/Yb, Eu/Nd) and its preparation method.

The following materials made, in mole percent composition, the rare earth ion-doped chloro alkali phosphate matrix glass with good thermal stability of the present invention:
40% P₂O₅-30% ZnO-10% BaF₂-18% LiCl-2% PbF₂ doped with 35000 ppm R₂O₃ (where R=Eu, Er, Yb, Nd) and codoped (R=Eu/Er, Eu/Yb, Eu, Nd).

The preparation method of produced with high thermal stability according to the present invention includes the following step 1:

The equivalent raw material weights are weighed and combined uniformly to create a combination in accordance with the intended composition ratio and the molar ratio of each component.

### Step 2:

Fill the silica, platinum, and alumina crucible with the mixture from the previous stage. Then, increase the furnace's temperature to 1000-1050° C. at a rate of 10° C. per minute, and maintain it there for two hours to melt the glass;

### Step 3: Forming and Annealing

To obtain Chloro Alkali Phosphate matrix glass that is undoped, doped, or codoped with high thermal stability, pour the glass melt that is obtained in the second step into a mold that has been preheated to 350° C. The mold should then be moved to a holding furnace that has been heated to 350-370° C. and annealed for two hours. After that, the temperature should be cooled to room temperature using the furnace.

In this method for preparing glass according to the present invention, the mold is a stainless steel.
3) In the produced Chloro Alkali Phosphate glass of this invention, the batch material in the crucible is covered to reduce OH— groups in the melt of glass.
4) The doped or codoped Chloro Alkali Phosphate glass is inexpensive, easy to use, and has superior all-around optical performance when prepared rare earth doped present glass is used.

The produced glass has low glass transition temperature in the range 370 to 394° C. comparing with other phosphate glasses prepared before.

The glass PZnBaLiPbEu—Er has highest thermal stability, (ΔT=T_{c}−T_{g}), where, ΔT=171° C.

In this invention, the density and refractive index, Sellmeier energy, Eₛ, dispersion energy E_{d}, and optical energy gap in (eV) of produced glass is stimulated.

The large value of optical energy gap (E_{g}=4.472 eV) corresponded to produced glass PZnBaLiPb doped with Yb ion.

In this invention, the value of dispersion energy, E_{d}, of produced glass is in the range between 13.32-16.08 eV. Furthermore, the value of Sellmeier energy, Eₛ, recorded from 6.54 to 9.95 eV.

In this invention, the lasing parameters such as, the measured fluorescence lifetime, The peak emission wavelength (λₚₑₐₖ, nm), effective bandwidths (Δλ_{eff}, nm), FWHM, The fluorescence lifetime (τₘₑₛ, μs), Peak emission cross-section (×10⁻²⁵ cm²), Gain, optical gain (σₑ×τₘₑₛ)×10⁻²⁵ cm² ms, and gain bandwidth (σₑ×Δλ_{eff})×10⁻²⁵ cm² of transition level of doped and undoped Chloro Alkali Phosphate stimulated, PZnBaLiPb

Therefore, in this invention, the producer of these glass could be suitable hosts for the lasing optical amplifier in the range from UV to NIR band from the results such as lasing parameters, thermal stability, chemical durability and low cost method of fabrication.

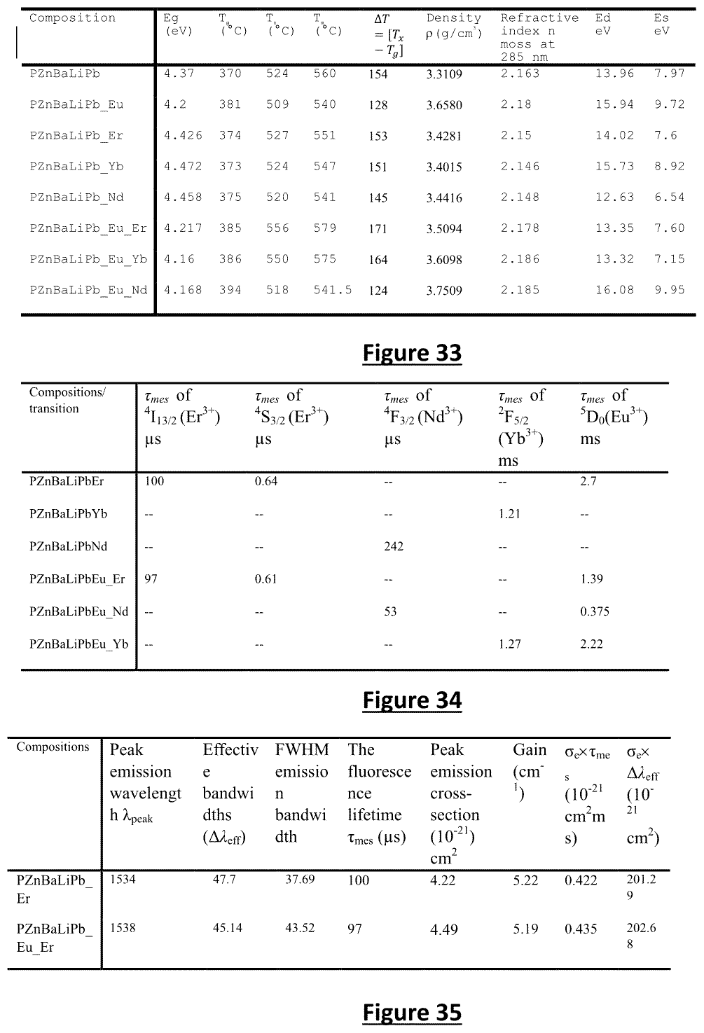

FIG. 2 illustrates DTA profile of all prepared glasses. FIG. 2 shows the DTA patterns of all prepared glasses. The glass transition (T_{g} in ° C.), the onset crystallization temperature (Tₓ in ° C.), and the crystallization temperature (Tₘ in ° C.) are listed in the Table in FIG. 33. From the FIG. 2, the transition temperature of the prepared glasses increase slightly with the addition the rare earth.

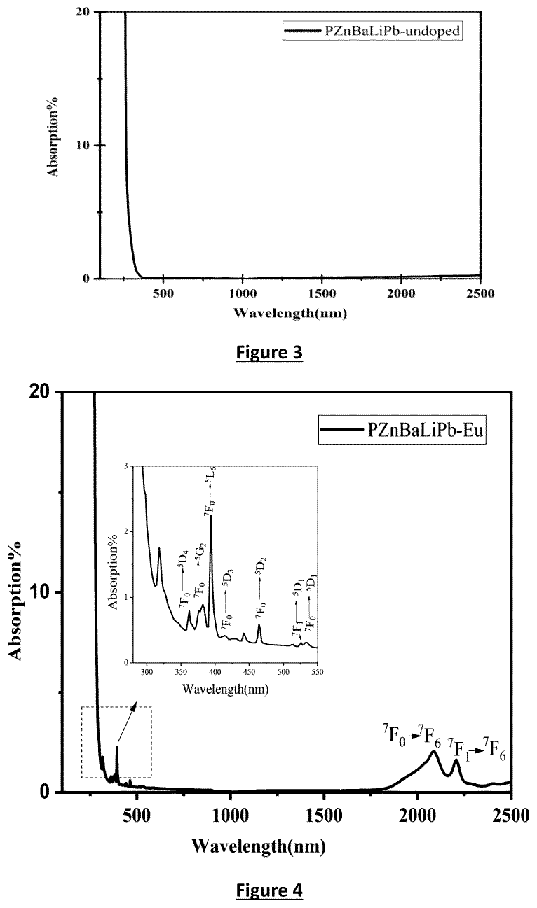

FIG. 3 illustrates the Absorption spectrum of PZnBaLiPb. FIG. 3 shows the absorption spectrum of the undoped glass PZnBaLiPb.

FIG. 4 illustrates the Absorption spectrum of PZnBaLiPb_Eu (35000 ppm). The absorption spectrum of the prepared glass PZnBaLiPb_Eu (35000 ppm) is shown in the FIG. 4 at room temperature. The FIG. 4 shows six absorption bands from the ground state ⁷F₀ at 2085 nm (⁷F₆), 534 nm (⁵D₁), 465 nm (⁵D₂), 394 nm (⁵L₆), 380 nm (⁵G₂) and 362 nm (⁵D₄), whereas other three peaks originates from ⁷F₁ state to 2207 nm (⁷F₆), 415 nm (⁵D₃) and 525 nm (⁵D₁).

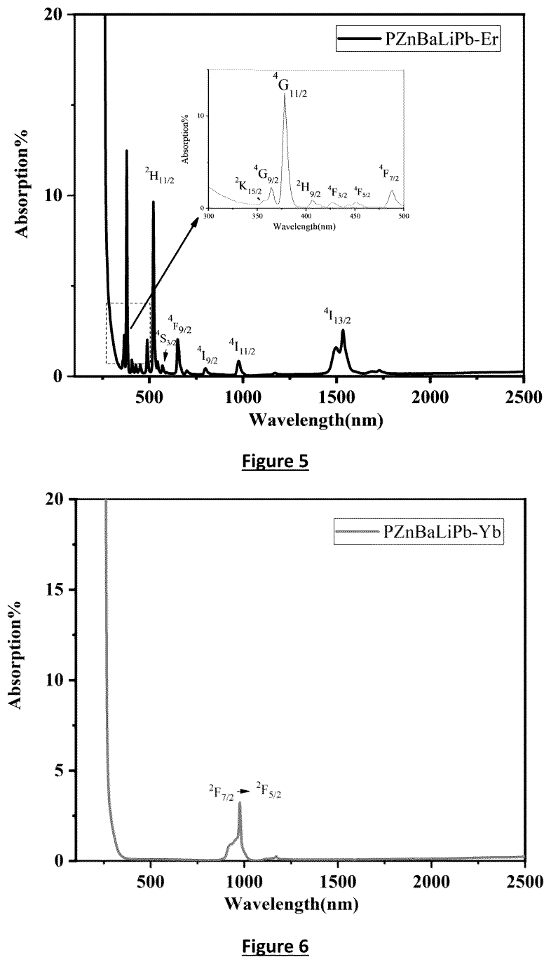

FIG. 5 illustrates the Absorption spectrum of PZnBaLiPb_Er (35000 ppm). FIG. 5 shows the absorption spectrum of the prepared glass PZnBaLiPb_Er (35000 ppm). The spectrum exhibit thirteen peaks at the wavelengths around 1514 nm, 974 nm, 797 nm, 648 nm, 564 nm, 522 nm, 487 nm, 452 nm, 442 nm, 406 nm, 377 nm, 363 nm, and 356 nm that correspond to the transition from the ground state of ⁴I_{15/2} to the exited state of ⁴I_{13/2}, ⁴I_{11/2}, ⁴I_{9/2}, ⁴F_{9/2}, ⁴S_{3/2}, ²H_{11/2}, ⁴F_{7/2}, ⁴F_{5/2}, ⁴F_{3/2}, ²H_{9/2}, ⁴G_{11/2}, ⁴G_{9/2}, and ²K_{15/2} respectively.

FIG. 6 illustrates the Absorption spectrum of PZnBaLiPb_Yb (35000 ppm). The optical absorbance spectrum in UV-VIS-NIR of the prepared glasses PZnBaLiPb_Yb (35000 ppm) is shown in the FIG. 6. FIG. 6 exhibit one peak at the wavelength around 977 nm that correspond to the transition from the ground state of ²F_{7/2} to the exited state of ⁴F_{5/2}.

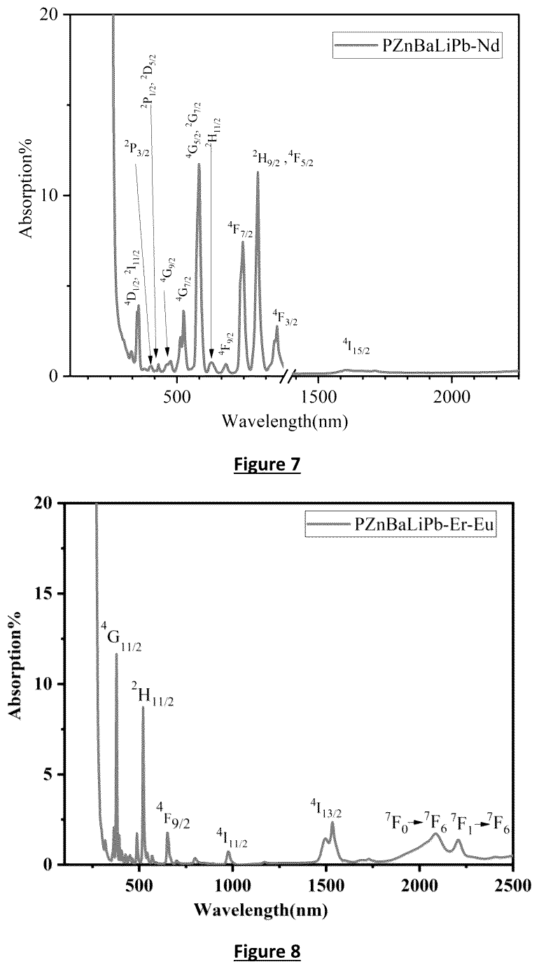

FIG. 7 illustrates the Absorption spectrum of PZnBaLiPb_Nd (35000 ppm). FIG. 7 shows the absorption spectrum of the prepared glass doped with Nd₂O₃. The absorption bands at 1583 nm, 874 nm, 800 nm, 745 nm, 684 nm, 629 nm, 578 nm 520 nm, 514 nm, 469 nm, 429 nm, and 398 nm are assigned to the transitions from ⁴I_{9/2} to ⁴I_{15/2}, ⁴F_{3/2}, ⁴F_{5/2}+²H_{9/2}, ⁴F_{7/2}, ⁴F_{9/2}, ²H_{11/2}, ⁴G_{5/2}+²G_{7/2}, ⁴G_{7/2}, ⁴G_{9/2}, ⁴D_{1/2}+²I_{11/2}, ⁴P_{1/2}+²D_{5/2} and ²P_{3/2}.

FIG. 8 illustrates the Absorption spectrum of PZnBaLiPb_Er (35000 ppm)_Eu (35000 ppm). In the FIG. 8, the absorption spectrum shows six bands, which are due to the intra 4f⁶-4⁶ electronic transition of Eu³⁺ ions from the ground state ⁷F₀ to ⁷F₆ (2085 nm) and from the state ⁷F₁ to ⁷F₆ (2207 nm), whereas the other observed transitions of Er³⁺ ions from the ground state of ⁴I_{51/2} to the exited state of ⁴I_{13/2} (1523 nm), ⁴I_{11/2} (979 nm), ²H_{11/2} (520 nm), and ⁴G_{11/2} (378 nm), respectively.

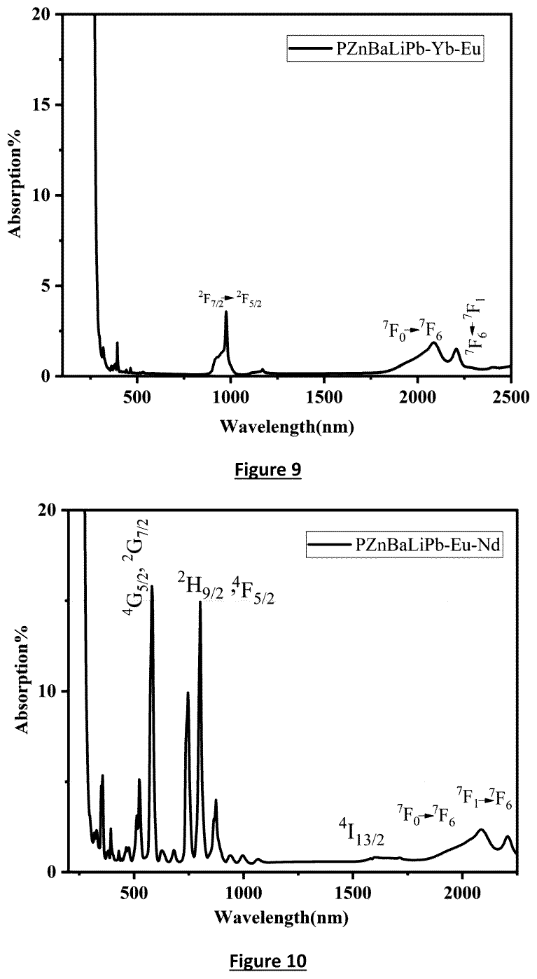

FIG. 9 illustrates the Absorption spectrum of PZnBaLiPb_Yb (35000 ppm)_Eu (35000 ppm). FIG. 9 shows the absorption spectrum of the glass PZnBaLiPb codoped Yb₂O₃ and Eu₂O₃ oxides. The absorption spectrum shows three intensives bands due to the transition of Eu³⁺ from the ground state ⁷F₀ to ⁷F₆ (2085 nm), and from the state ⁷F₁ to ⁷F₆ (2207 nm), whereas the last observed transitions of the Yb³⁺ from the ground state of ²F_{7/2} to the exited state of ⁴F_{5/2} (977 nm).

FIG. 10 illustrates the Absorption spectrum of PZnBaLiPb_Nd (35000 ppm)_Eu (35000 ppm). FIG. 10 shows the absorption spectrum of the prepared glass PZnBaLiPb codoped Nd₂O₃ and Eu₂O₃ oxides. The intensive absorption bands at 1583 nm, 800 nm, and 578 nm are assigned to the transitions of the ions Nd³⁺ from ⁴I_{9/2} to ⁴I_{13/2}, ⁴F_{5/2}+²H_{9/2}, ⁴G_{5/2}+²G_{7/2}, whereas the other observed transitions of Eu³⁺ ions from the ground state ⁷F₀ to ⁷F₆ (2085 nm), then from the state ⁷F₁ to ⁷F₆ (2207 nm).

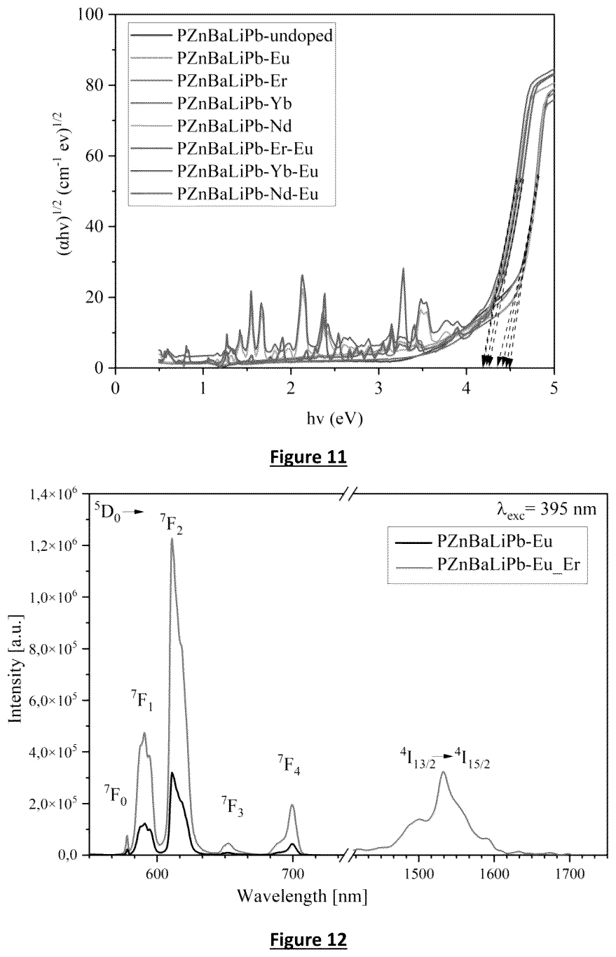

FIG. 11 illustrates the (αhν)^{1/2} as a function of (hν) of all prepared glasses. FIG. 11 shows the measured energies gaps for all prepared glasses. The measured energy gap for each glass are listed in the table in FIG. 33.

The energy gap of the undoped glass PZnBaLiPb recorded a value equal to 4.37 eV. The doping of the glass with Eu₂O₃ oxides decrease this value to 4.2 (FIG. 11). While, the glass PZnBaLiPb doped with Yb₂O₃ recorded the highest optical energy gap which equal to 4.472 eV, that makes this glass interesting for some optical devices.

FIG. 12 illustrates the fluorescence emission spectra of PZNBaLiPb_Eu and PZnBaLiPb_Eu—Er glasses under an excitation wavelength of 395 nm. The fluorescence emission spectra of PZNBaLiPb_Eu and PZnBaLiPb_Eu—Er glasses under an excitation wavelength of 395 nm is shown in FIG. 12. The emission spectra UV-NIR appeared six emissions. One NIR emission band centered at 1534 nm attributed to ⁴I_{13/2}→⁴I_{15/2} transition of Er³⁺ ions. Meanwhile, five emission peaks centered at 699 m, 651 nm, 610 nm, 590 nm, and 578 nm attributed to ⁵D_{0→}⁷F₄, ⁵D_{0→}⁷F₃, ⁵D_{0→}⁷F₂, ⁵D_{0→}⁷F₁, and ⁵D_{0→}⁷F₀ transitions of Eu³⁺ ions, respectively.

The emission spectrum of the glass PZnBaLiPb doped with Eu₂O₃ oxide shows an interesting emission intensity under an excitation wavelength of 395 nm (FIG. 12). UV-Visible luminescence spectrum of Eu³⁺ ions of the prepared glasses is registered upon excitation of ⁵L₆ state. Owing to small energy gaps between ⁵L₆, ⁵D₂, ⁵D₁ and ⁵D₀ states, the excitation energy transfers nonradiative very fast to the ₅D₀ state. Next, visible emission corresponding to the ⁵D₀-⁷F_{J} (J=0, 1, 2, 4) transitions of Eu³⁺ ions is observed in the prepared glasses PZnBaLiPbEu and PZnBaLiPbEu—Er. The main red luminescence band at about 611 nm corresponds to ⁵D₀-⁷F₂ transition of Eu³⁺ ions. The ratio of integrated emission intensity of the ⁵D₀-⁷F₂ transition to the ⁵D₀-⁷F₁ transition, defined as red-to-orange fluorescence intensity ratio R/O (and usually referred as R factor), is relative to the strength of covalent/ionic bonding between the Eu³⁺ ions and the surrounding ligands. The emission intensity of the glass PZnBaLiPb codoped with Eu₂O₃ and Er₂O₃ oxides is higher that the emission intensity of PZnBaLiPbEu which can be explained with the energy transfer from Eu³⁺ ions to Er³⁺ ions.

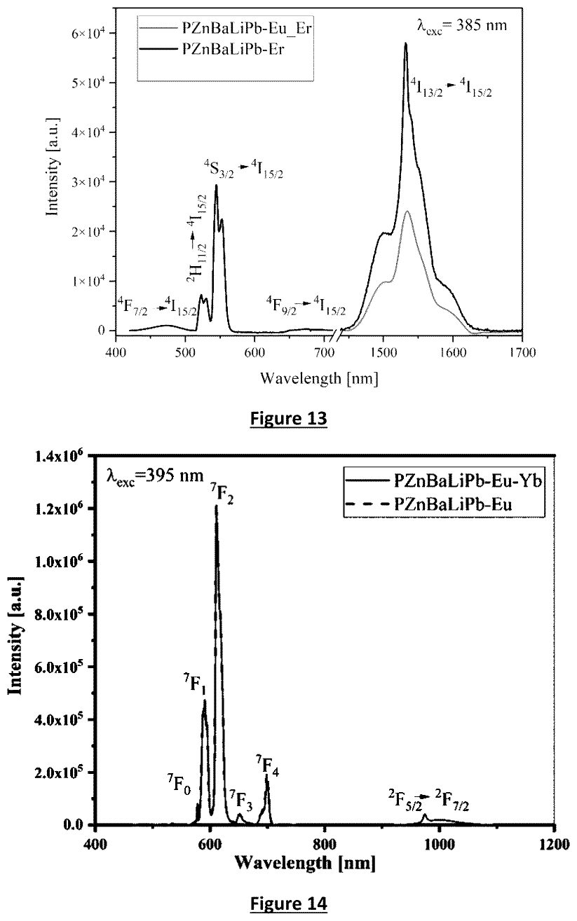

FIG. 13 illustrates the fluorescence emission spectra of PZNBaLiPb_Er and PZnBaLiPb_Eu—Er glasses under an excitation wavelength of 385 nm. The FIG. 13 shows the emission spectra of PZnBaLiPbEr and PZnBaLiPbEu—Er glasses under an excitation wavelength of 385 nm. The emission spectra at 1534 nm is attributed to ⁴I_{13/2→}⁴I_{15/2} transition, whereas all the other observed transitions are the emission peaks of Er³⁺ ions attributed to ⁴F_{9/2→}⁴I_{15/2}, ⁴S_{3/2→}⁴I_{15/2}, ²H_{11/2→}⁴I_{15/2}, and ⁴F_{4/2→}^{4I}_{15/2} transitions centred at 650 nm, 545 nm, 525 nm, and 470 nm, respectively.

The emission spectrum of the glass PZnBaLiPb doped with Er₂O₃ oxide shows an interesting emission intensity under an excitation wavelength of 385 nm (FIG. 13). The intensity of emission band at 1535 nm due to the main ⁴I_{13/2}→⁴I_{15/2} (Er³⁺) near-infrared laser transition is reduced by cooping the glass with Eu₂O₃ which can be explained with the energy transfer between the ions Er³⁺ and Eu³⁺.

FIG. 14 illustrates the fluorescence emission spectra of PZNBaLiPb_Eu and PZnBaLiPb_Eu—Yb glasses under an excitation wavelength of 395 nm. FIG. 14 shows the fluorescence emission spectra of PZNBaLiPb_Eu and PZnBaLiPb_Eu—Yb glasses under an excitation wavelength of 395 nm. The spectra shows six emission peaks. The NIR emission peak centered at 975 nm is attributed to the transition ²F_{5/2→}²F_{7/2} of Yb³⁺ ions. Meanwhile, five emission peaks centered at 699 m, 651 nm, 610 nm, 590 nm, and 578 nm attributed to ⁵D_{0→}⁷F₄, ⁵D_{0→}⁷F₃, ⁵D_{0→}⁷F₂, ⁵D_{0→}⁷F₁, and ⁵D_{0→}⁷F₀ transitions of Eu³⁺ ions, respectively.

Yb³⁺ ion contains only two states and has strong absorption at ˜976 nm and a resonant fluorescent emission is observed at this wavelength. On the other hand, Eu³⁺ ions do not absorb 976 nm radiation and so, it does not show any fluorescence when excited with 395 nm wavelength. However, in the presence of a trace amount of Yb³⁺ ions (35000 ppm) and of Eu³⁺ ions (35000 ppm), the emission spectrum exhibits a broad red emission centered at ˜970 nm due to the cooperative emission of Yb³⁺ ions and a strong orange/red emission of Eu³⁺ ion corresponding to ⁵D₀→⁷Fᵢ (i=0 to 4) transitions, as depicted in FIG. 14.

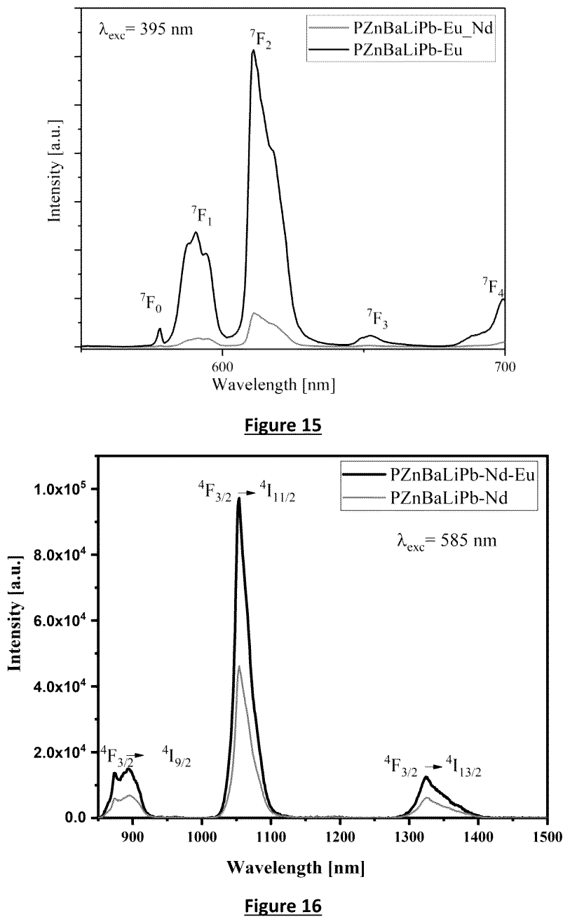

FIG. 15 illustrates the fluorescence emission spectra of PZNBaLiPb_Eu and PZnBaLiPb_Eu—Nd glasses under an excitation wavelength of 395 nm. FIG. 15 shows the fluorescence emission spectra of PZNBaLiPb_Eu and PZnBaLiPb_Eu—Nd glasses under an excitation wavelength of 395 nm. The five emission peaks are attributed to ⁵D_{0→}⁷F₄, ⁵D_{0→}⁷F₃, ⁵D_{0→}⁷F₂, ⁵D_{0→}⁷F₁, and ⁵D_{0→}⁷F₀ transitions of Eu³⁺ ions, centered at 699 m, 651 nm, 610 nm, 590 nm, and 578 nm, respectively.

The emission spectrum of the glass PZnBaLiPb doped with Eu₂O₃ oxide shows an interesting emission intensity under an excitation wavelength of 395 nm (FIG. 15). The ⁵D₀→⁷F₂ level is the most intense emission than the other transitions. Eu³⁺ emission intensity has been decreased with addition of Nd³⁺ ions owing to ET between these ions. This decrease has been ascribed due to overlap of Eu³⁺ emission and Nd³⁺ absorption.

FIG. 16 illustrates the fluorescence emission spectra of PZNBaLiPb_Nd and PZnBaLiPb_Eu—Nd glasses under an excitation wavelength of 585 nm. The fluorescence emission spectra of PZNBaLiPb_Nd and PZnBaLiPb_Eu—Nd glasses under an excitation wavelength of 585 nm are shown in the FIG. 16. All the emission peaks are attributed to the Nd³⁺ ions transition. The NIR emission peak are attributed to ⁴F_{3/2→}⁴I_{13/2} transition centered at 1325 nm, and to ⁴F_{3/2→}⁴I_{11/2} transition centered at 1054 nm, respectively. The emission peak centered at 895 nm is corresponding to the transition ⁴F_{3/2→}⁴I_{9/2}.

Contrary, with the addition of Eu₂O₃ to the glass PZnBaLiPb—Nd, the emission spectrum of the glass PZnBaLiPbNd_Eu under an excitation wavelength of 585 nm (FIG. 16) shows an emission intensity more intense than the emission intensity of PZnBaLiPb—Nd. The ⁴F_{3/2}→⁴I_{11/2} transition has been predominant among other transitions. It can be concluded that the intensity of the codoped glass increase with the ET between these ions.

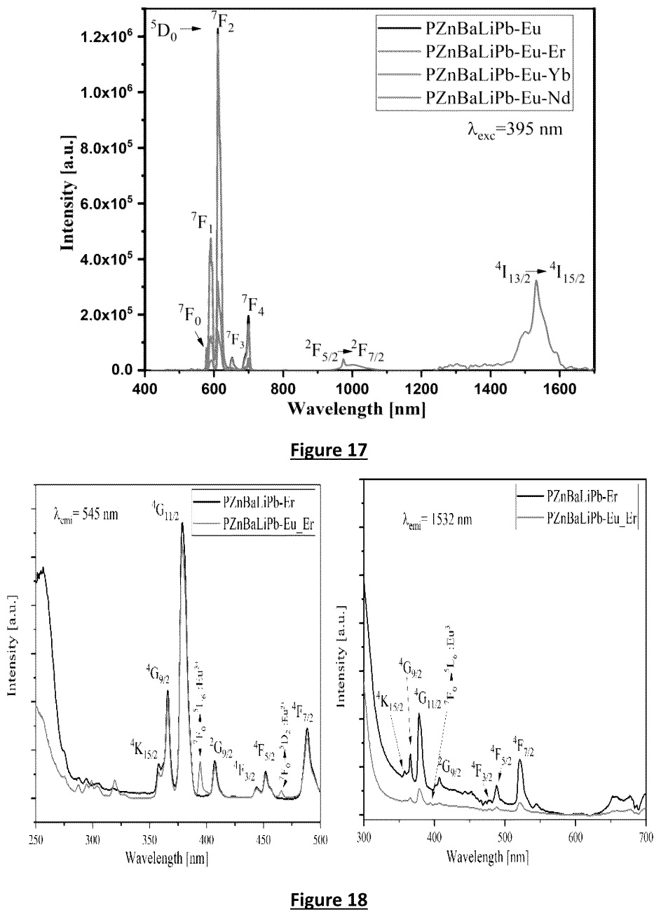

FIG. 17 illustrates the fluorescence emission spectra of PZNBaLiPb_Eu, PZnBaLiPb_Eu−x (x=Er, Yb, Nd) glasses under an excitation wavelength of 395 nm. PZnBaLiPb_Eu exhibit the highest emission intensity. The emission intensity decrease with addition of the rare earths ions Yb³⁺, Er³⁺ and Nd³⁺, respectively, which can be explained with the ET between the different ions.

FIG. 18 illustrates the excitation spectra of PZNBaLiPb_Eu and PZnBaLiPb_Eu—Er glasses under different emission wavelength of 545 nm and 1532 nm. The Stark splitting has been well observed in these spectra. Several narrowed and well-resolved bands are originating to transitions from the ⁴I_{15/2} ground state to the ⁴F_{7/2}, ⁴F_{5/2}, ⁴F_{3/2}, ²G_{9/2}, ⁴G_{11/2}, ⁴G_{9/2} and ²K_{15/2} excited states of Er³⁺ ions. However, the presence of the Eu³⁺ ions in the codoped glass exhibit an excitation peaks are originating to transitions from the ⁷F₀ state to the ⁵D₂ and ⁵L₆ excited states of Eu³⁺ ions.

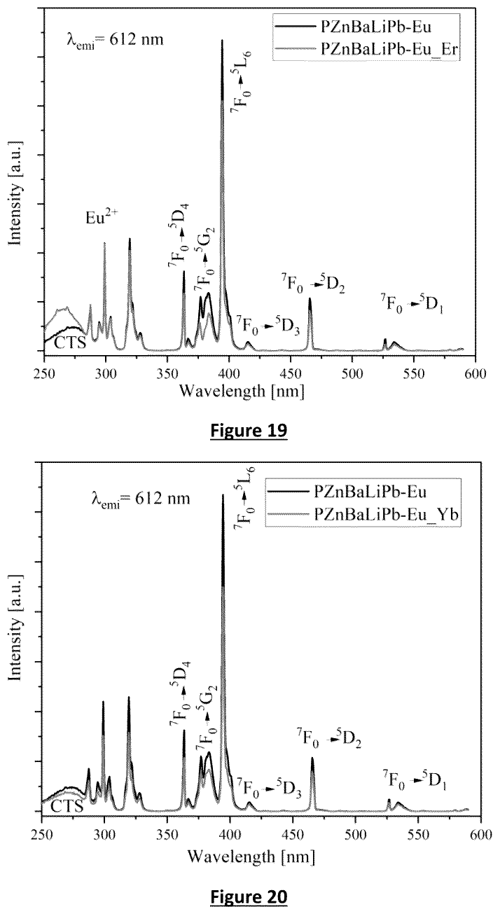

FIG. 19 illustrates the excitation spectra of PZNBaLiPb_Eu and PZnBaLiPb_Eu—Er glasses under an emission wavelength of 612 nm. The spectra represent six peaks correspond to the transitions of Eu³⁺ ions. The excitation peaks are corresponding to the Eu³⁺ ions. With the addition of the Er³⁺ ions in the codoped glass, the intensity of the excitation decrease which can be explained with the ET between these ions.

FIG. 20 illustrates the excitation spectra of PZNBaLiPb_Eu and PZnBaLiPb_Eu—Yb glasses under an emission wavelength of 612 nm. The spectra represent six peaks correspond to the transitions of Eu³⁺ ions. The codoped glass exhibit a decreasing in the excitation intensity which can prove the ET between Eu³⁺ and Yb³⁺ ions.

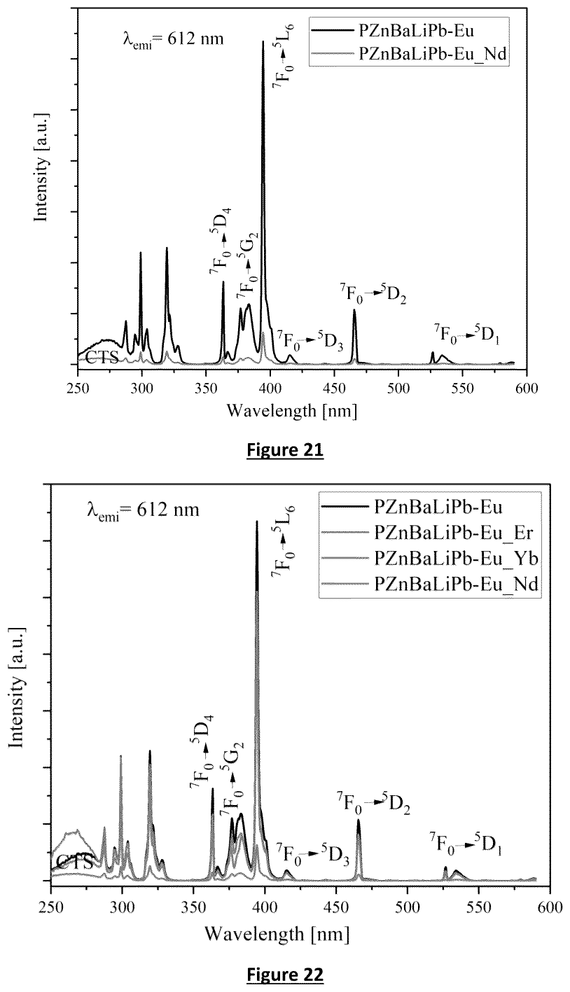

FIG. 21 illustrates the excitation spectra of PZNBaLiPb_Eu and PZnBaLiPb_Eu—Nd glasses under an emission wavelength of 612 nm. From FIG. 20, six excitation peaks are observed in both single and co-doped glasses which are labeled as ⁷F₀→⁵D₁ (534 nm), ⁷F₀→⁵D₂ (465 nm), ⁷F₀→⁵D₃ (415 nm), ⁷F₀→⁵L₆ (394 nm), ⁷F₀→⁵G₂ (383 nm) and ⁷F₀→⁵D₄ (364 nm), respectively. Among all the transitions, ⁷F₀→⁵L₆ (394 nm) is more intense than other transitions. The excitation intensity peaks of co-doped glass decrease comparing with the intensity of PZnBaLiPb_Eu glass which ions owing to ET between these ions.

FIG. 22 illustrates the excitation spectra of PZNBaLiPb_Eu and PZnBaLiPb_Eu−x (x=Er, Nd, Yb) glasses under an emission wavelength of 612 nm. The doped glass record the important excitation intensity. The codoping of this glass with others ions owing to the ET between the rare earth ions which reduce the intensity of the spectra.

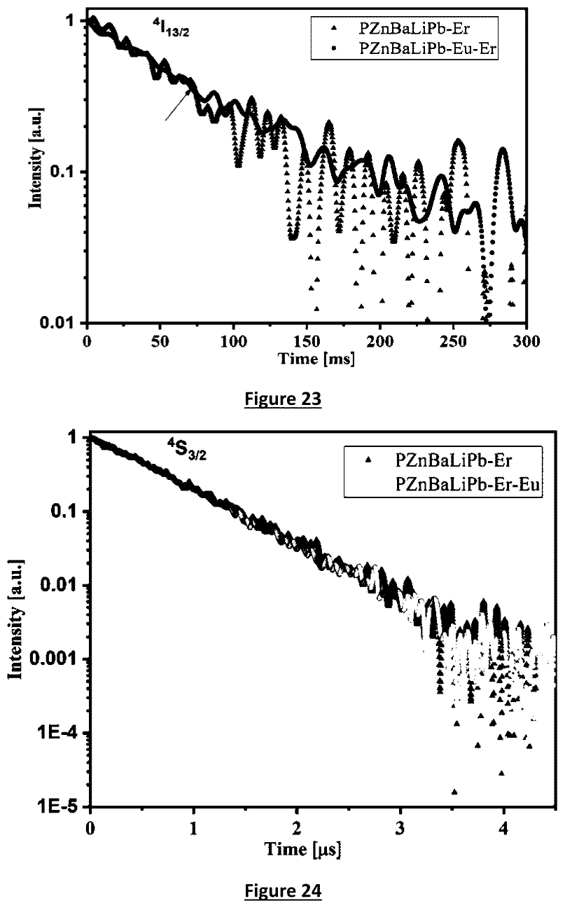

FIG. 23 illustrates the Fluorescence decay curve of PZnBaLiPbEr and PZnBaLiPbEr_Eu glasses: ⁴I_{13/2} state of Er³⁺ ions. The idea of energy transfer is strengthened by the decay curve analysis, which is fitted in second order exponential in Er_Eu codoped glass, in place of single exponential used in singly doped Er³⁺ glass (see FIG. 23). Theoretically, multiphonon relaxation rate increases exponentially as the energy gap ΔE between the two energy levels decreases. The luminescence lifetimes for ⁴I_{13/2} states of Er³⁺ rare earth ions in the phosphate glasses decrease from 100 μs to 97 μs which owing to the energy transfer between Er³⁺ and Eu³⁺ ions.

FIG. 24 illustrates the Fluorescence decay curve of PZnBaLiPbEr and PZnBaLiPbEr_Eu glasses: ⁴S_{3/2} state of Er³⁺ ions. The luminescence lifetimes for ⁴S_{3/2} states of Er³⁺ rare earth ions in the phosphate glasses reduced from 0.64 μs to 0.61 μs which owing to the energy transfer between Er³⁺ and Eu³⁺ ions which causes accumulation of population at this level and yielded intense green emission.

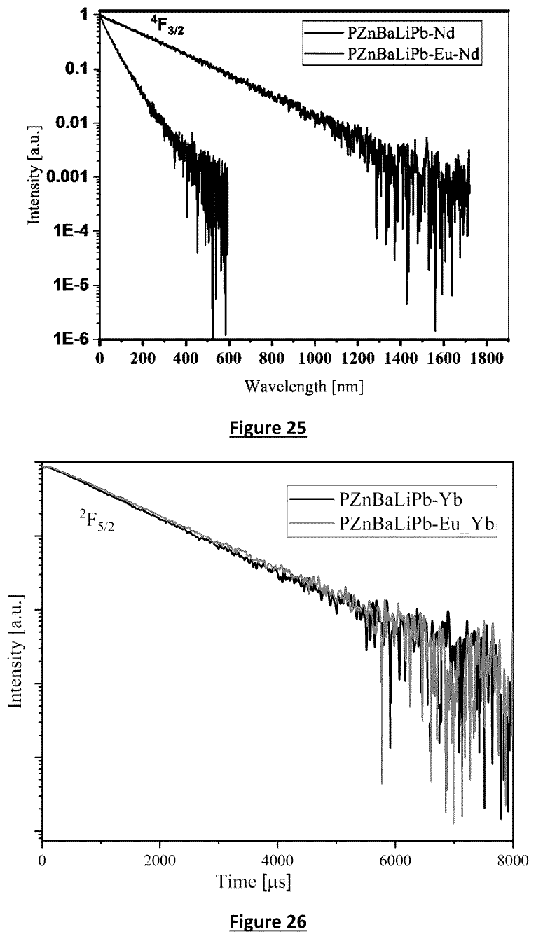

FIG. 25 illustrates the Fluorescence decay curve of PZnBaLiPbNd and PZnBaLiPbEu_Nd glasses: ⁴F_{3/2} state of Nd³⁺ ions. It can be observed that both glasses exhibit non-exponential behavior and the lifetimes are found to be 242 μs for single PZnBaLiPbNd and 53 μs for co-doped PZnBaLiPbEu_Nd glass. It can be concluded that the lifetime for co-doped glass is decreased compared to single doped glass, may be due to some unwanted cross-relaxation channels during ET process.

FIG. 26 illustrates the Fluorescence decay curve of PZnBaLiPbYb and PZnBaLiPbEu_Yb glasses: ²F_{5/2} state of Yb³⁺ ions. For the codoped glass, an increase, in the emission lifetime is observed in the presence of Eu³⁺ ions and are estimated to be 1.21 ms and 1.27 ms for the single and codoped glasses respectively.

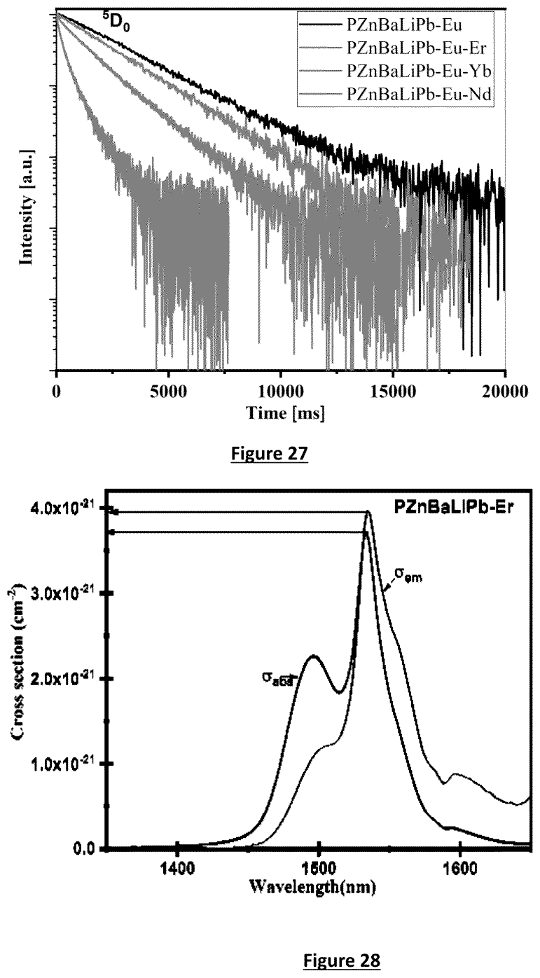

FIG. 27 illustrates the Fluorescence decay curve of PZnBaLiPbEu and PZnBaLiPbEu_X (X=Er, Yb, Nd) glasses: ⁵D₀ state of Eu³⁺ ions. The fluorescence decay rates have been determined for single and all co-doped glasses with different rare earth ions. FIG. 27 shows the decay curves of ⁵D₀ luminescent level of Eu³⁺ ions of PZnBaLiPbEu and PZnBaLiPbEu/X (X=Er, Yb, Nd) glass. From FIG. 27, the observed lifetime for PZnBaLiPbEu glass is estimated to be 2.7 ms, whereas the experimental lifetime of the codoped PZnBaLiPbEu/X (X=Er, Yb, Nd) glasses are found to be 1.39 ms, 2.22 ms and 0.375 ms, respectively. With the presence of the trace of the codoped ions, the lifetime is reduced for the codoped PZnBaLiPbEu/X (X=Er, Yb, Nd) glasses than that of single PZnBaLiPbEu glass.

FIG. 28 illustrates the Absorption and emission cross section for PZnBaLiPb—Er glass of the transition ⁴I_{13/2}→⁴I_{15/2}. PZnBaLiPb—Er glass exhibits a large effective bandwidth (Δλ_{eff}) comparing to PZnBaLiPbEu_Er glass (see FIGS. 28-30). Both glasses glass recorded an interesting optical gain (σₑ×τₘₑₛ) and gain bandwidth (σₑ×Δλ_{eff}) at 1534 nm laser transition for the Erbium ions.

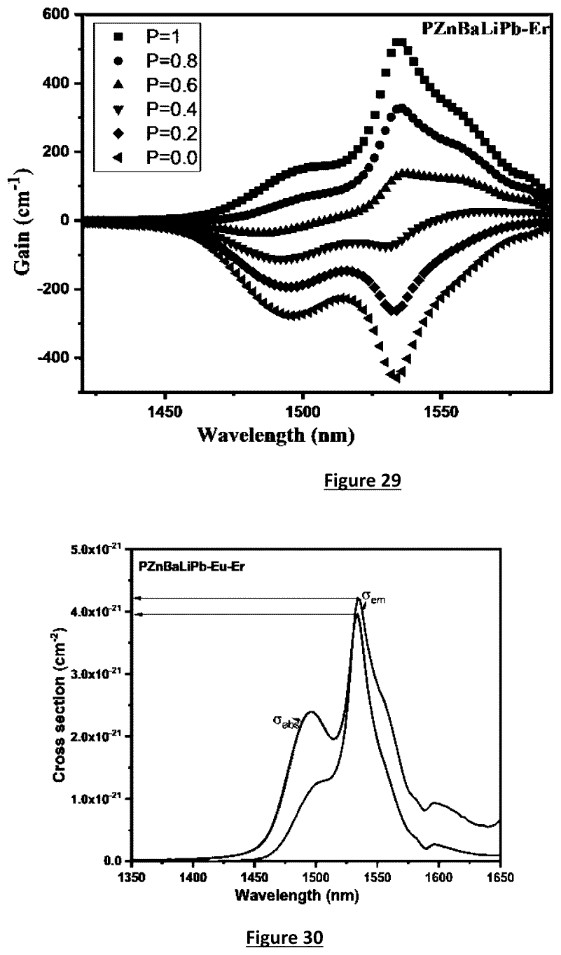

FIG. 29 illustrates the Gain coefficient for of the transition ⁴I_{13/2}→⁴I_{15/2} of PZnBaLiPb—Er glass. All the parameters related to the emission cross-section and the gain are listed in table in FIG. 34.

FIG. 30 illustrates the Absorption and emission cross section for PZnBaLiPb-Er_Eu glass of the transition ⁴I_{13/2}→⁴I_{15/2}.

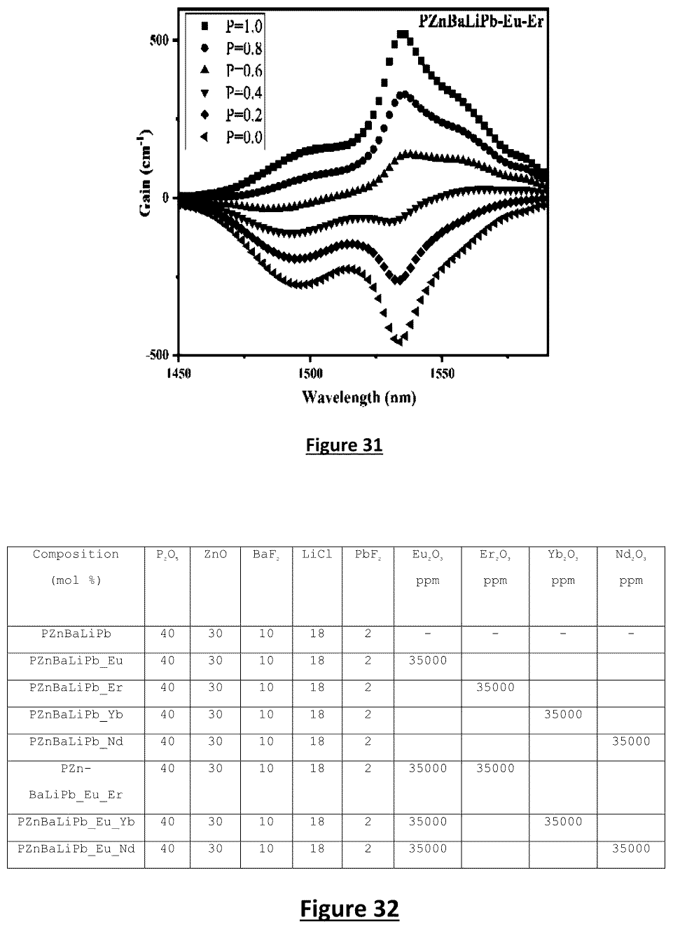

FIG. 31 illustrates the Gain coefficient for of the transition ⁴I_{13/2}→⁴I_{15/2} of PZnBaLiPb-Er_Eu glass. All the parameters related to the emission cross-section and the gain are listed in table in FIG. 34.

FIG. 32 illustrates a Table depicting the composition of the prepared glasses.

FIG. 33 illustrates a Table depicting density, refractive index, glass transition temperature T_{g}, onset crystallization temperature Tₓ, crystallization temperature Tₘ, thermal stability ΔT, Sellmeier Eₛ and dispersion energy E_{d}, and optical energy gap in (eV) of prepared glasses.

FIG. 34 illustrates a Table depicting the measured fluorescence lifetime of all prepared glasses.

FIG. 35 illustrates a Table depicting the peak emission wavelength (λₚₑₐₖ, nm), effective bandwidths (Δλ_{eff}, nm), FWHM, The fluorescence lifetime (τₘₑₛ, μs), Peak emission cross-section (×10⁻²¹ cm²), Gain, optical gain (σₑ×τₘₑₛ)×10⁻²¹ cm² ms, and gain bandwidth (σₑ×Δλ_{eff})×10⁻²¹ cm².

In this invention preparation glass composition with high concentration of both halides ions F and Cl to reduce OH molecules in the glass matrix

The produced glass in this invention with composition 40% P2O5-30% ZnO-10% BaF2-18% LiCl-2% PbF2-35000 ppm R2O3 (R=Eu, Er, Yb, Nd, Eu/Er, Eu/Yb, Eu/Nd).

In this invention the production glass has wide optical energy gap (4.16-4.472 eV) hence, it is superior host material of homogeneity and solubility of rare ions.

The produced glass in this invention has low glass transition temperature compared with other glass system pure phosphate, silicate and borate glass.

In this invention the produced glass is superior thermal stability material with high anticrystallization (ΔT in the range from 124 to 171° C.

The advantage of the glass in this invention has high transmission related to halides ions F and Cl in the glass matrix

The glass PZnBaLiPb—Er has the peak emission wavelength at (λₚₑₐₖ=1534 nm), effective bandwidths (Δλ_{eff}=47.4 nm), FWHM=37.69 nm, The fluorescence lifetime at (τₘₑₛ=100 μs), emission cross-section (4.22×10⁻²¹ cm²), Gain=5.22 cm⁻¹, optical gain (σₑ×τₘₑₛ=0.422×10⁻²¹ cm² ms), and gain bandwidth (σₑ×Δλ_{eff}=201.29×10⁻²¹ cm²)

The glass PZnBaLiPb—Er—Eu has the peak emission wavelength at (λₚₑₐₖ=1538 nm), effective bandwidths (Δλ_{eff}=45.14 nm), FWHM=43.52 nm, The fluorescence lifetime at (τₘₑₛ=97 μs), emission cross-section (4.49×10⁻²¹ cm²), Gain=5.19 cm⁻¹, optical gain (σₑ×τₘₑₛ=0.435×10⁻²¹ cm² ms), and gain bandwidth (σₑ×Δλ_{eff}=202.68×10⁻²⁵ cm²)

Acknowledgements: The authors extend their appreciation to University Higher Education Fund for funding this research work under Research Support Program for Central labs at King Khalid University

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above about specific embodiments. However, the benefits, advantages, solutions to problems, and any component(s) that may cause any benefit, advantage, or solution to occur or become more pronounced are not to be construed as a critical, required, or essential feature or component of any or all the claims.

1. A composition for fabricating Chloro Alkali Phosphate Doped/Codoped by rare earth ions for optical laser amplifiers, the composition comprises:
38-42 wt. % of Phosphorus pentoxide (P₂O₅);
28-32 wt. % of Zinc oxide (ZnO);
9-11 wt. % of Barium fluoride (BaF₂);
17-19 wt. % of Lithium chloride (LiCl); and
1-3 wt. % of Lead(II) fluoride (PbF₂).

2. The composition of claim 1, wherein the weight amount of the P₂O₅, ZnO, BaF₂, LiCl, PbF₂, is preferably, 40%, 30%, 10%, 18%, and 2%, respectively.

3. The composition of claim 1, wherein said composition is doped with 35000 ppm R₂O₃ where R is selected from Eu, Er, Yb, Nd whereas codoped with 35000 ppm R₂O₃ where R is selected from Eu/Er, Eu/Yb, Eu, Nd.

4. A process for preparing composition of claim 1, the process comprises:
a) mixing 38-42 wt. % of Phosphorus pentoxide (P₂O₅), 28-32 wt. % of Zinc oxide (ZnO), 9-11 wt. % of Barium fluoride (BaF₂), 17-19 wt. % of Lithium chloride (LiCl), and 1-3 wt. % of Lead(II) fluoride (PbF₂);
b) filling a silica, platinum, and alumina crucible to the mixture;
c) heating the mixture upon increasing a furnace temperature to 1000-1050° C. with the rate of 10° C. per minute and maintaining the temperature for two hours to melt the glass; and
d) pouring the glass melt into a preheated stainless steel mold at 350° C. and transferring the mold to a holding furnace heated to 350-370° C. and annealing for two hours thereby cooling to room temperature to obtain Chloro Alkali Phosphate matrix glass.

5. The process of claim 4, wherein the mold is preferably of a stainless steel, wherein a batch material in the crucible is covered to reduce OH— groups in the glass melt, and wherein the produced Chloro Alkali Phosphate glass has a low glass transition temperature ranging from 370 to 394° C.

6. The process of claim 4, wherein the mixture of 40% P₂O₅-30% ZnO-10% BaF₂-18% LiCl-2% PbF₂ doped with 35000 ppm R₂O₃ where R is selected from Eu, Er, Yb, Nd whereas codoped with 35000 ppm R₂O₃ where R is selected from Eu/Er, Eu/Yb, Eu, Nd.

7. The process of claim 4, wherein the glass composition PZnBaLiPbEu—Er has a thermal stability of 124-171° C., wherein the optical energy gap of the produced glass doped with Yb ion is 4.472 eV, and wherein dispersion energy (Ed) of the produced glass falls within a range of 13.32 to 16.08 eV, and Sellmeier energy (Es) ranges from 6.54 to 9.95 eV, wherein the produced glass compositions are suitable hosts for lasing optical amplifiers in the UV to NIR band based on their lasing parameters, thermal stability, chemical durability, and low-cost fabrication method.

8. The process of claim 4, wherein the mixture is subjected to a controlled atmosphere during the heating stage, specifically in an inert argon or nitrogen gas environment, to minimize oxidation of the constituent materials and prevent contamination of the glass melt, ensuring a uniform composition with minimal defect states and enhanced optical clarity, and wherein the rate of temperature increase in the furnace is precisely controlled using a programmable logic controller (PLC) with a temperature fluctuation tolerance of ±1° C. to ensure uniform heating throughout the mixture, thereby preventing localized overheating or thermal stresses that could lead to phase separation or microcracks within the glass matrix.

9. The process of claim 4, further comprising:
pre-treating the Phosphorus pentoxide (P2O5) to remove any adsorbed moisture content by preheating at 200-250° C. in a vacuum desiccator for a period of one hour prior to mixing, thereby reducing the potential for hydrolysis reactions during the high-temperature melting process;
a secondary annealing process after the initial two-hour annealing period, wherein the mold is gradually cooled at a controlled rate of 2° C. per minute to a temperature of 250° C. before being allowed to cool to room temperature in a desiccated environment, to reduce internal stresses and improve the mechanical durability of the glass.

10. The process of claim 4, wherein the produced glass is subjected to a high-precision polishing procedure post-annealing, utilizing a series of progressively finer diamond abrasives down to 0.1 μm grit size, to achieve a surface roughness (Ra) of less than 5 nm, enhancing the glass's suitability for high-precision optical applications requiring minimal surface scattering, and wherein the mixture doped with 35000 ppm of R2O3, where R is selected from Eu, Er, Yb, Nd, and co-doped with Eu/Er, Eu/Yb, or Eu/Nd, is stirred continuously using a mechanical stirrer with a platinum-coated shaft at a speed of 50-100 RPM during the heating phase to ensure homogeneous distribution of dopants and prevent phase segregation within the glass matrix.

11. The process of claim 4, wherein the mixture of Phosphorus pentoxide (P2O5), Zinc oxide (ZnO), Barium fluoride (BaF2), Lithium chloride (LiCl), and Lead(II) fluoride (PbF2) is subjected to an ultrasonic agitation treatment at a frequency of 20-25 kHz for 15-20 minutes prior to heating to promote thorough mixing and de-agglomeration of the powder constituents, ensuring a homogeneous distribution of components and reducing the likelihood of phase separation during the melting process, and wherein the heating of the mixture is performed in a two-zone furnace, where the initial preheating zone gradually raises the temperature to 600° C. at a rate of 5° C. per minute to remove any volatile impurities, followed by a rapid transition to the high-temperature melting zone set at 1000-1050° C., thereby optimizing the thermal profile to prevent thermal shock and enhance the glass forming ability of the composition.

12. The process of claim 4, wherein the produced glass melt is subjected to a controlled magnetic stirring using a magnetically coupled stirring system with a rotation speed of 150-200 RPM during the pouring process into the stainless steel mold, to maintain uniform temperature distribution and prevent the formation of thermal gradients within the molten glass, ensuring a consistent microstructure throughout the glass body, and wherein the thermal stability of the PZnBaLiPbEu—Er glass composition is further enhanced by doping with 0.1-0.5 wt. % of rare-earth oxides such as Cerium oxide (CeO2) or Samarium oxide (Sm2O3), which act as nucleating agents to control crystallization during the cooling phase, thereby refining the glass microstructure and improving resistance to devitrification.

13. The process of claim 4, wherein the glass melt, after pouring into the preheated stainless steel mold, undergoes a rapid quenching process in a controlled atmosphere chamber filled with an inert gas mixture of argon and helium at a pressure of 0.8-1 atm, to achieve a high cooling rate that inhibits crystallization and maintains the amorphous nature of the Chloro Alkali Phosphate matrix glass.

14. The process of claim 4, further comprising a step of subjecting the annealed glass to an electron beam irradiation process at an energy level of 2-3 MeV for 5-10 minutes to induce defect healing and improve the glass's optical transparency and photoluminescence properties by minimizing point defects and color centers that could arise during the high-temperature processing, and wherein the mixture doped with 35000 ppm R2O3, where R is selected from Eu, Er, Yb, Nd, and co-doped with Eu/Er, Eu/Yb, or Eu/Nd, is subjected to a high-frequency microwave-assisted synthesis process during the mixing phase, applying microwave radiation at 2.45 GHz to enhance the diffusion rates of the dopants into the glass network, leading to improved homogeneity and increased optical activation efficiency.

15. The process of claim 4, wherein the mold used for pouring the glass melt is pre-coated with a release agent comprising a thin layer of boron nitride (BN) to prevent adhesion between the glass and the mold surface, thereby facilitating easy demolding and reducing the risk of surface imperfections or defects on the final glass product, wherein the prepared Chloro Alkali Phosphate matrix glass is further treated with a chemical strengthening bath containing a molten mixture of potassium nitrate and sodium nitrate salts at a temperature of 450-500° C., followed by a rapid cooling phase in a chilled oil bath, to induce surface compression layers that enhance the glass's mechanical toughness and resistance to surface scratches and fractures.

16. The process of claim 4, wherein the mixture is subjected to an ion-beam-assisted deposition (IBAD) treatment during the mixing phase, where a directed beam of ions such as Argon or Oxygen ions is applied to the mixture, enhancing the bonding energy between Phosphorus pentoxide (P2O5) and Zinc oxide (ZnO) molecules, thereby increasing the structural integrity and chemical durability of the resulting Chloro Alkali Phosphate matrix glass, and wherein the heating step includes a stepwise thermal cycling protocol in which the temperature is repeatedly increased and decreased in controlled increments of 50° C. up to the target temperature of 1000-1050° C., creating a controlled thermal shock environment that refines the microstructure of the glass matrix by promoting uniform nucleation and preventing large crystalline growth.

17. The process of claim 4, wherein the mixture is doped with dual rare-earth elements in a controlled ratio of 1:1, and subjected to a high-temperature plasma annealing step post-melting, where the glass melt is exposed to a high-energy plasma environment at 1200° C. for 10 minutes, which activates rare-earth ions into higher oxidation states, significantly enhancing the photoluminescence and lasing properties of the glass for ultraviolet to near-infrared (UV-NIR) applications, and wherein the annealing step is performed under a fluctuating magnetic field of 1-2 Tesla, generated by an external electromagnetic coil, to induce magnetic domain alignment within the doped ions in the glass, thereby creating anisotropic optical properties that improve light amplification and signal gain for specific wavelengths in optical amplifier applications.

18. The process of claim 4, wherein the Lead(II) fluoride (PbF2) content is precisely calibrated and introduced in a stepwise manner during the heating phase, using a computer-controlled feeder mechanism to gradually increase the PbF2 concentration in the melt, thereby controlling the refractive index gradient and enhancing the optical dispersion properties of the glass for specific refractive index matching applications, and wherein the process further comprising an ultrasonic cavitation treatment of the glass melt immediately after pouring into the stainless steel mold, where the mold is subjected to ultrasonic waves at 40 kHz frequency for 5 minutes to reduce the viscosity of the glass melt and promote rapid degassing, thereby minimizing the formation of microbubbles and ensuring a defect-free, optically transparent glass matrix.

19. The process of claim 4, wherein the glass melt is mixed with nano-sized silica particles (10-50 nm) during the final 10 minutes of the heating phase, utilizing a high-shear mixing apparatus that operates at 10,000 RPM, to enhance the mechanical strength and thermal shock resistance of the glass without compromising its optical properties, thereby making it suitable for high-power laser applications, and wherein the Chloro Alkali Phosphate glass matrix is further coated with a thin film of antireflective material using atomic layer deposition (ALD), where layers of hafnium oxide (HfO2) and silicon dioxide (SiO2) are alternately deposited at sub-nanometer thicknesses to achieve a broadband antireflective surface with reduced Fresnel reflections, enhancing the efficiency of optical transmission in photonic devices.

20. The process of claim 4, wherein the cooling step in the holding furnace is performed in a gradient-controlled manner, where the temperature of the furnace is reduced at varying rates across different sections of the glass mold, creating a gradient thermal environment that induces compressive stress layers on the glass surface, significantly improving the glass's resistance to crack propagation and mechanical failure under thermal cycling conditions, and wherein the composition is subjected to a dual laser irradiation process, involving simultaneous irradiation with both a continuous wave laser at 532 nm and a pulsed laser at 1064 nm, during the final phase of annealing, to selectively modify the electronic band structure and enhance the non-linear optical properties of the glass, such as second harmonic generation and two-photon absorption.
